(19) United States
(12) Patent Application Publication
(10) Pub. No.: US 2026/0016586 A1
(43) Pub. Date: Jan. 15, 2026

(54) Range Measurement

(71) Applicant: Cypress Semiconductor Corporation, San Jose, CA (US)

(72) Inventors: Mateo BRUBNJAK, Villach (AU); Giuseppe LI PUMA, Bochum (DE)

(73) Assignee: Cypress Semiconductor Corporation, San Jose, CA (US)

(21) Appl. No.: 18/767,976

(22) Filed: Jul. 9, 2024

(51) Int. Cl. G01S 13/10; G01S 7/292; G01S 7/4915

(52) U.S. Cl. CPC G01S 13/103; G01S 7/292; G01S 7/4915

(57) ABSTRACT

A phase based range measurement solution is provided comprising (i) determining several phase differences, wherein cach phase difference is based on a pair of phase measurements; (ii) determining a total phase difference based on the several phase differences, wherein each of the phase difference is weighted; and (iii) determining the range based on the total phase difference.

### TECHNICAL FIELD

This disclosure generally relates to technologies for positioning and ranging using wireless signals.

### BACKGROUND

As is described in [P. Zand, J. Romme, J. Govers, F. Pasveer and G. Dolmans, “A high-accuracy phase-based ranging solution with Bluetooth Low Energy (BLE),” 2019 IEEE Wireless Communications and Networking Conference (WCNC), 2019, pp. 1-8, doi: 10.1109/WCNC.2019.8885791], Multi-Carrier Phase Difference (MCPD) is a transmitter-to-transmitter based ranging solution used in different technologies. In the Bluetooth standard, MCPD is engaged for High-Accuracy Distance Measurement (HADM), also denoted as Channel Sounding (CS), to localize the position of a Bluetooth device. MCPD utilizes a series of phase measurements across multiple frequency channels. This localization is also referred to as MCPD-ranging.

MCPD-ranging uses an initiator (also referred to as master) and a reflector (also referred to as slave). The initiator is the device that starts the ranging procedure and the reflector is the responding device.

After two devices have established a connection, the initiator transmits an unmodulated constant tone, a Local Oscillator (LO) signal, to the reflector on a first channel. The reflector performs a phase measurement Φ_{R} on the received carrier and sends back a constant tone, i.e., its LO, to the initiator on the same channel. The initiator then performs a phase measurement Φ_{I}.

This procedure is repeated on a number of K_{f} channels. At the end of the procedure, the reflector sends measurement results over the entire frequency band to the initiator, allowing the initiator to calculate the range (see also U.S. Pat. No. 9,274,218 B2).

The phase measurements across the channels are denoted as:

$$\begin{matrix}Φ [ k ] = {Φ}_{I} [ k ] + {Φ}_{R} [ k ] , & k = 0 , 1 , … , {K}_{f} - 1\end{matrix} \qquad ( 1 )$$

A range r can be computed as follows:

$$r = - \frac{{c}_{0}}{2 \cdot Δω} \cdot mean ( ΔΦ [ 1 ] , ΔΦ [ 2 ] , … , ΔΦ [ {K}_{f} - 1 ] ) \qquad ( 2 )$$

$$where$$

$$ΔΦ [ k ] = Φ [ k ] - Φ [ k - 1 ] \qquad ( 3 )$$

is a phase difference of adjacent channels.

Equation (2) represents the final step of the ranging algorithm described in [P. Zand, J. Romme, J. Govers, F. Pasveer and G. Dolmans, “A high-accuracy phase-based ranging solution with Bluetooth Low Energy (BLE),” 2019 IEEE Wireless Communications and Networking Conference (WCNC), 2019, pp. 1-8, doi: 10.1109/WCNC.2019.8885791]. However, this approach only uses phase differences between adjacent channels, which results in a reduced ranging precision.

The same ranging algorithm may be applied in radar systems based on the Stepped-Frequency Continuous-Wave (SFCW) method.

It is an objective to provide an improved solution, in particular an improved ranging precision for systems utilizing phase measurement information.

### BRIEF DESCRIPTION OF THE DRAWINGS

Embodiments are shown and illustrated with reference to the drawings. The drawings serve to illustrate the basic principle, so that only aspects necessary for understanding the basic principle are illustrated. The drawings are not to scale. In the drawings the same reference characters denote like features.

FIG. 1 shows a diagram depicting a total number of K_{f}=8 channels comprising two pairings.

FIG. 2 shows a diagram depicting a total number of K_{f}=8 channels with four pairs, each pair combining two channels.

FIG. 3 shows a diagram comprising a total number of K_{f}=8 channels visualizing different distances d of equidistant pairings.

FIG. 4 shows an example of an extended equidistant pairing based on the subdiagram 304 of FIG. 3.

FIG. 5 shows a diagram that illustrates the FAR MP category utilizing equidistant pairing from peak to peak (or valley to valley)

FIG. 6 shows a diagram that illustrates the MID MP category utilizing equidistant pairing from peak to valley.

FIG. 7 shows a diagram that illustrates the NEAR MP category comprising an amplitude of the IQ samples across the channels.

FIG. 8 shows a diagram that illustrates the NEAR MP category with a limited range for the pairing patterns.

FIG. 9 illustrates an example flow diagram of a method for operating a device to conduct range measurements.

FIG. 10 shows an example block diagram visualizing different use cases for a system implementation utilizing range measurements.

FIG. 11 illustrates a block diagram of a system useable for range measurement.

### DETAILED DESCRIPTION

A notation of phase variables is as follows:
Φ—non-Italic, non-bold—deterministic unwrapped phase
Φ—non-Italic, bold—deterministic wrapped phase
Φ—Italic, non-bold—stochastic unwrapped phase
Φ—Italic, bold—stochastic wrapped phase

Hence, the following applies:

$$Φ = ϕ ( mod 2 π )$$

It is noted that the term “increasing precision” in particular refers to reducing the standard deviation of the range measurement. Further, the term “deviation” refers to “standard deviation”, which in particular assumes a normal (e.g., random) distribution.

### Legacy Approach

Reference is made to [P. Zand, J. Romme, J. Govers, F. Pasveer and G. Dolmans, “A high-accuracy phase-based ranging solution with Bluetooth Low Energy (BLE),” 2019 IEEE Wireless Communications and Networking Conference (WCNC), 2019, pp. 1-8, doi: 10.1109/WCNC.2019.8885791].

The wrapped phase measurement of each channel is denoted as:

$$\begin{matrix}Φ [ k ] , & k = 0 , 1 , … ,\end{matrix} {K}_{f} - 1 , \qquad ( 4 )$$

with a total number of channels K_{f} and a channel index k. A frequency of the channel k is defined as

$$ω [ k ] = {ω}_{0} + k \cdot Δω , \qquad ( 5 )$$

wherein ω₀ is a carrier frequency of the 0^{th} (first) channel and Δω is a frequency difference between adjacent channels.

Next, a phase difference between adjacent channels is determined:

$$ΔΦ [ k ] = Φ [ k ] - Φ [ k - 1 ] , k = 1 , 2 , ... , {K}_{f} - 1 \qquad ( 6 )$$

For a valid range measurement with MCPD-ranging, the phase difference between all adjacent channels is preferably less than 2π, i.e.,

$$ΔΦ [ k ] < 2 π , for any k . \qquad ( 7 )$$

Therefore, the unwrapped phase difference is the same as the wrapped, i.e.:

$$ΔΦ [ k ] = ΔΦ [ k ] , for any k . \qquad ( 8 )$$

In [P. Zand, J. Romme, J. Govers, F. Pasveer and G. Dolmans, “A high-accuracy phase-based ranging solution with Bluetooth Low Energy (BLE),” 2019 IEEE Wireless Communications and Networking Conference (WCNC), 2019, pp. 1-8, doi: 10.1109/WCNC.2019.8885791] it is noted that the range is directly proportional to the phase difference between any two adjacent channels:

$$r = - \frac{{c}_{0}}{2 \cdot Δω} \cdot ΔΦ [ k ] , for any k , \qquad ( 9 )$$

wherein c₀ is the speed of light.

Therefore, the range can be calculated from two adjacent channels by Equation (9).

The precision of the range measurement is increased by using an average of all phase differences:

$${ΔΦ}_{avg} = mean ( ΔΦ [ 1 ] , ΔΦ [ 2 ] , ... , ΔΦ [ {K}_{f} - 1 ] ) \qquad ( 10 )$$

The range is then equal to

$$r = - \frac{{c}_{0}}{2 \cdot Δω} \cdot {ΔΦ}_{avg} \qquad ( 11 )$$

### Example Embodiments

Examples described herein may be based on stochastic analysis, i.e., treating the phase measurement errors as random (or randomized) variables.

The standard deviation of the phase measurements is directly proportional to the standard deviation of the range measurement. Examples described herein aim to reduce this deviation, thereby increasing the precision of the range measurement.

The phase measurement Φ[k] of each channel can be modeled as a (e.g., random) variable with a normal (gaussian) probability distribution.

$$Φ [ k ] ∼ 𝒩 ( μ [ k ] , {σ}^{2} [ k ] ) , μ [ k ] = Φ [ k ] \qquad ( 12 )$$

It is assumed that the mean of the distribution substantially corresponds to the deterministic phase measurement.

The following assumptions are made:
(a) The phase measurement of each channel has the same standard deviation σ, i.e., σ[k]=σ, for any k.
(b) There is no cross-correlation ρ in phase measurements between any two channels, i.e., ρ[m, n]=0, m, n=1,2, . . . , K_{f}−1, (m≠n).

Hence, the final notation for the stochastic wrapped phase measurement amounts to

$$Φ [ k ] ∼ 𝒩 ( μ [ k ] , {σ}^{2} ) , μ [ k ] = Φ [ k ] . \qquad ( 13 )$$

Also, an unwrapped phase has the same deviation as a wrapped phase, i.e.:

$$Φ [ k ] ∼ 𝒩 ( μ [ k ] , {σ}^{2} ) , μ [ k ] = Φ [ k ] . \qquad ( 14 )$$

The following assumptions are a starting point made for the purpose of streamlining the stochastic analysis, but are not intended to limit the cases to which the approach presented herein can be applied.

A stochastic analysis can be applied to the ΔΦ_{avg} term of Equation (10). This average of all phase differences is directly proportional to the range r as shown in Equation (11).

### Example Algorithm

To utilize phase measurements from all channels, the following approach can be used:

The phase difference of adjacent channels is determined as follows:

$$ΔΦ [ k ] = Φ [ k ] - Φ [ k - 1 ] , k = 1 , 2 , ... , {K}_{f} - 1 \qquad ( 15 )$$

The phase across all channels is unwrapped by a cumulative summation of the phase differences:

$$Φ [ 0 ] = 0 \qquad ( 16 )$$

$$Φ [ k ] = Φ [ 0 ] + {\sum }_{i = 1}^{k} ΔΦ [ i ] , k = 1 , ... , {K}_{f} - 1$$

The starting point can be chosen at the 0^{th} channel and it can be defined as 0. It is noted that any starting point may be used, as long as phase differences between the channels are maintained.

It is noted that phase differences are not limited to adjacent channels.

The unwrapping done in Equation (15) allows taking the phase difference between any two channels as a separate range measurement.

Next, a scaled phase difference is introduced utilizing a channel delta:

$${ΔΦ}_{s} [ m , n ] = \frac{Φ [ n ] - Φ [ m ]}{n - m} = \frac{Φ [ n ] - Φ [ m ]}{d [ m , n ]} , n > m \qquad ( 17 )$$

wherein, the channel delta is defined as

$$d [ m , n ] = n - m \qquad ( 18 )$$

A range r can be calculated from the scaled phase difference for any pair of m and n:

$$r = - \frac{{c}_{0}}{2 \cdot Δω} \cdot {ΔΦ}_{s} [ m , n ] \qquad ( 19 )$$

The stochastic value of the scaled phase difference is:

$$Δ {Φ}_{s} [ m , n ] = \frac{Φ [ n ] - Φ [ m ]}{n - m} \qquad ( 20 )$$

Following from the assumptions (a) and (b) above, the deviation of the scaled phase difference is:

$${σ}_{Δ {ϕ}_{s}} = \frac{\sqrt{{σ}^{2} + {σ}^{2}}}{n - m} = σ \cdot \frac{\sqrt{2}}{n - m} \qquad ( 21 )$$

The range r can be measured from the unwrapped phase difference between any two channels. Hence, any channel pair may correspond to an individual range measurement.

A deviation of the range measurement is directly proportional to the deviation of the scaled phase difference, which is inversely-proportional to the channel delta of the m and n channel pair.

Also, the deviation can be improved utilizing a mean of multiple scaled phase differences, which is defined as a total phase difference:

$$Δ {Φ}_{tot} = mean ( {ΔΦ}_{s} [ {m}_{1} , {n}_{1} ] , {ΔΦ}_{s} [ {m}_{2} , {n}_{2} ] , … ) \qquad ( 22 )$$

The selection of m and n may have a significant impact to obtain a suitable level of precision. Pairs with small channel deltas have worse standard deviation according to Equation (21).

In many cases, precision may be further improved by employing a weighted mean as follows:

$$Δ {Φ}_{tot} = mean ( {g}_{1} \cdot {ΔΦ}_{s} [ {m}_{1} , {n}_{1} ] , {g}_{2} \cdot {ΔΦ}_{s} [ {m}_{2} , {n}_{2} ] , … ) \qquad ( 23 )$$

where optimized weights (g₁, g₂, . . . ) can be determined according to [Handbook of Mathematics, 6th Edition [2015]—I. N. Bronshtein, K. A. Semendyayev, Gerhard Musiol, Heiner Mühlig, page 854]. Alternatively, the optimized weights can be iteratively derived as will be explained below.

In the following, examples may introduce grouping of [m, n] channel pairs.

Therefore, a channel pair index u is defined:

$$Δ {Φ}_{s} [ {m}_{u} , {n}_{u} ] = Δ {Φ}_{s} [ u ] \qquad ( 24 )$$

$$d [ {m}_{u} , {n}_{u} ] = d [ u ]$$

### Example: Two Channel Pairs

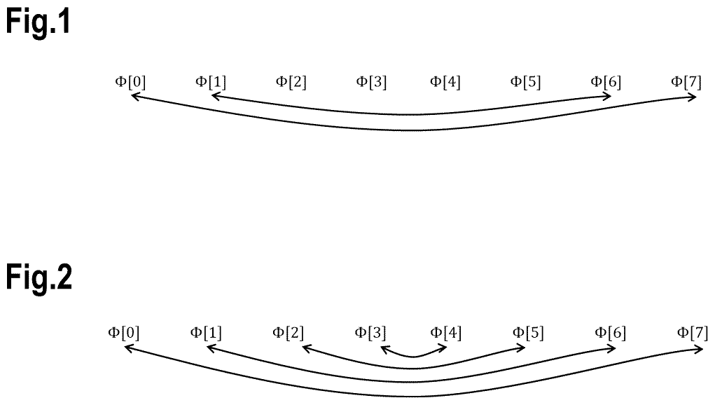

FIG. 1 shows a diagram depicting a total number of K_{f}=8 channels. As described above, Φ[k] (with k=0, . . . , K_{f}−1) is an unwrapped phase measurement for the respective channel k.

In the example shown in FIG. 1, two [m, n] channel pairs [0,7] and [1,6] are selected and the total phase difference ΔΦₜₒₜ according to Equation (22) is determined as follows:

$$Δ {Φ}_{tot} = \frac{\frac{Φ [ 7 ] - Φ [ 0 ]}{7} + \frac{Φ [ 6 ] - Φ [ 1 ]}{5}}{2} \qquad ( 25 )$$

with an associated deviation of the total phase difference amounting to

$${σ}_{Δ {Φ}_{tot}} = σ \cdot \frac{\sqrt{{( \frac{\sqrt{2}}{7} )}^{2} + {( \frac{\sqrt{2}}{5} )}^{2}}}{2} = σ \cdot 0.174 \qquad ( 26 )$$

Hence, the deviation of the total phase difference is scaled by 0.174, which is an improvement compared to only a single outer pair:

$$Δ {Φ}_{s} = \frac{Φ [ 7 ] - Φ [ 0 ]}{7} \to {σ}_{Δ {Φ}_{s}} = σ \cdot \frac{\sqrt{2}}{7} = σ \cdot 0.202 \qquad ( 27 )$$

In a subsequent example, a higher number of channel pairs will be considered.

### Example: Symmetrical Pairing

FIG. 2 shows a diagram depicting a total number of K_{f}=8 channels with four pairs, each pair combining two channels. It is noted that the selection shown in FIG. 2 is merely an example and other combinations of channel pairings may be used as well.

For an arbitrary number of channels, symmetrical pairing indexes can be defined as follows:

$$u = 1 , 2 , … , U \qquad ( 28 )$$

wherein u is the pair index and U is the number of used pairs, with

$$max ( U ) = \frac{{K}_{f}}{2} \qquad ( 29 )$$

$${m}_{u} = u - 1$$

$${n}_{u} = {K}_{f} - u$$

The channel delta equals

$$d [ u ] = {K}_{f} + 1 - 2 u \qquad ( 30 )$$

The resulting scaled phase difference of each pair with the index u amounts to:

$$Δ {Φ}_{s} [ {m}_{u} , {n}_{u} ] = Δ {Φ}_{s} [ u ] = \frac{ϕ [ {n}_{u} ] - ϕ [ {m}_{u} ]}{{K}_{f} + 1 - 2 u} \qquad ( 31 )$$

Hence, for an arbitrary number of channels K_{f}, pairs can be determined one after the other starting from the edges, towards the middle. The total phase difference at each point U amounts to:

$$Δ {Φ}_{tot} [ U ] = \frac{1}{U} \cdot {\sum }_{u = 1}^{U} Δ {Φ}_{s} [ u ] , U = 1 , … , \frac{{K}_{f}}{2} \qquad ( 32 )$$

The term ΔΦₛ[u] is the scaled phase difference defined in Equation (20), U is the number of pairs that have been added up to that point.

The deviation of the total phase difference can be denoted as follows:

$${ΔΦ}_{tot} [ U ] = σ \cdot \frac{\sqrt{{\sum }_{u = 1}^{U} {( \frac{\sqrt{2}}{{K}_{f} + 1 - 2 u} )}^{2}}}{U} \qquad ( 33 )$$

With this example, the precision can be significantly increased compared to prior art solutions. The outer pairs with the greatest delta between the channels have the smallest deviations. Initially, with each added pair, a reduction in the deviation of the total is achieved. However, due to the large deviation of the middle pairs, at some point their addition increases the deviation of the total. Hence, it is an option to omit those middle pairs that contribute to the deviation increase (e.g., by comparing those to be (non) omitted with a threshold).

To further reduce the deviation, a weighted averaging of random variables can be utilized.

### Example: Improvement by Weighted Averaging

N₁ and N₂ are normal (e.g., random) distributions with standard deviation values σ₁ and σ₂, respectively. The normal distributions N₁ and N₂ are uncorrelated, i.e.

$$ρ ( {N}_{1} , {N}_{2} ) = 0 \qquad ( 34 )$$

Also, N₂ is assumed to have a worse deviation by a factor of X, i.e.

$${σ}_{2} = X \cdot {σ}_{1} , X > 1. \qquad ( 35 )$$

The weighted mean M of two variables (here, the normal distributions N₁ and N₂) is defined as follows:

$$\begin{matrix}M = {g}_{1} \cdot {N}_{1} + {g}_{2} \cdot {N}_{2} \\ {g}_{1} + {g}_{2} = 1\end{matrix} \qquad ( 36 )$$

The standard deviation σ_{M} for the mean M can be determined as follows:

$$\begin{matrix}{σ}_{M} = \sqrt{{( {g}_{1} {σ}_{1} )}^{2} + {( {g}_{2} {σ}_{2} )}^{2}} = \\ = \sqrt{{( {g}_{1} {σ}_{1} )}^{2} + {( ( 1 - {g}_{1} ) \cdot {σ}_{1} \cdot X )}^{2}} = \\ = {σ}_{1} \cdot \sqrt{{g}_{1}^{2} \cdot ( 1 + {X}^{2} ) - 2 {g}_{1} {X}^{2} + {X}^{2}}\end{matrix} \qquad ( 37 )$$

A partial derivative with respect to the weight g₁ is used to find the minimum standard deviation:

$$\frac{\partial ( {g}_{1}^{2} \cdot ( 1 + {X}^{2} ) - 2 {g}_{1} {X}^{2} + {X}^{2} )}{\partial {g}_{1}} = 2 {g}_{1} \cdot ( 1 + {X}^{2} ) - 2 {X}^{2} \qquad ( 38 )$$

Then, the weight is determined, which results in a minimum standard deviation, i.e.:

$$2 {g}_{{1}_{min}} \cdot ( 1 + {X}^{2} ) - 2 {X}^{2} = 0 \qquad ( 39 )$$

$${g}_{{1}_{min}} = \frac{{X}^{2}}{{X}^{2} + 1} \qquad ( 40 )$$

Next, this optimized weight g₁_{ₘᵢₙ} is inserted back into Equation (37) to find the minimum standard deviation, i.e.:

$${σ}_{{M}_{min}} = {σ}_{1} \cdot \sqrt{\frac{{X}^{2}}{{X}^{2} + 1}} \qquad ( 41 )$$

Hence, the optimum weights result in the minimum deviation of the mean M and can be determined based on Equation (40):

$${g}_{1} = \frac{{X}^{2}}{{X}^{2} + 1} , {g}_{2} = 1 - {g}_{1} \qquad ( 42 )$$

Applying the optimum weights, the minimum deviation results in Equation (41).

Hence, a larger factor X leads to a reduced benefit from the second distribution N₂.

### Example: Applying Weights to Symmetrical Pairing

To obtain optimum weights, the following iterative optimum weighted averaging method can be used:
a. Select a single pair as first datapoint. It is noted that any pair can be selected.
b. Subsequently add the remaining pairs: The weights at each iteration can be calculated according to Equation (42), wherein the normal distribution N₁ corresponds to the full sum up to that point and N₂ denotes the newly added pair of channels.
c. The resulting optimum weight g[u] for each pair is calculated from the product of all the weights which were applied to that pair across the whole iterative procedure.
d. The sum of all g[u] weights should be 1.

Hence, the total phase difference with a weighted mean equals:

$$Δ {Φ}_{tot} = {\sum }_{u = 1}^{U} g [ u ] \cdot {ΔΦ}_{s} [ u ] \qquad ( 43 )$$

$$with$$

$${\sum }_{u = 1}^{U} g [ u ] = 1 \qquad ( 44 )$$

This approach bears the advantage that the deviation is gradually reduced with each channel pair being added with optimized weights.

It is noted that the example of symmetrical pairing is one of several approaches to obtain an improved precision.

### Intermediate Conclusion

Examples described herein lead to an improved ranging precision compared to prior art solutions. For example, some embodiments for improving ranging precision may be based on one or more of
Cumulatively adding phase differences to obtain the unwrapped phase for each channel-Equation (16).
Definition of scaled phase difference according to Equation (17).
Obtaining the range from a mean of multiple of scaled phase differences according to Equation (22).

Embodiments may further improve ranging precision by utilizing one or more of:
Selecting an array of scaled phase differences.
Defining the weights for each pair in a weighted averaging operation.

By obtaining the unwrapped phases, each channel pair can be processed as a distinct range measurement. The subsequent optimization steps, i.e., selecting the scaled phase differences and their weights can be done in different ways. The selection itself may significantly impact the precision improvement. The solution described herein may be used to yield an optimized precision.

Examples described herein can be utilized for Bluetooth High-Accuracy Distance Measurement (HADM) or in any Multi-Carrier Phase Difference (MCPD) ranging feature, as well as Stepped-Frequency Continuous-Wave (SFCW) radar.

Solutions described herein may be implemented in hardware, firmware and/or software.

### Example: Pairing Approach in Systems with Non-Constant Frequency Channel Delta

The examples above are based on the assumption that the frequency channels are spaced with a constant frequency difference Δω, as described in Equation (5). In addition to this example, the spacing between frequency channels may (at least partially) be different from each other. Insofar, the distances between the channels Φ[k] shown in FIG. 2 need not to be equidistant.

In such case, symmetrical pairing can be used. Without the constant frequency difference Δω, the angular frequency for each channel is denoted as:

$$ω [ k ] k = 1 , … , {K}_{f} \qquad ( 45 )$$

Hence, the scaled phase difference can be replaced with a phase-over-frequency term as follows:

$$\frac{Δ ϕ}{Δ ω} [ m , n ] = \frac{Φ [ n ] - Φ [ m ]}{ω [ n ] - ω [ m ]} \qquad ( 46 )$$

For an example with K_{f}=8, according to symmetrical pairing the range is determined as:

$$r = - \frac{{c}_{0}}{2} \cdot mean ( \frac{Δ ϕ}{Δ ω} [ 0 , 7 ] , \frac{Δ ϕ}{Δ ω} [ 1 , 6 ] , \frac{Δ ϕ}{Δ ω} [ 2 , 5 ] , \frac{Δ ϕ}{Δ ω} [ 3 , 4 ] ) \qquad ( 47 )$$

Furthermore, the precision can be improved by utilizing a weighted mean according to:

$$r = - \frac{{c}_{0}}{2} \cdot mean ( {g}_{07} \cdot \frac{Δ ϕ}{Δ ω} [ 0 , 7 ] , {g}_{16} \cdot \frac{Δ ϕ}{Δ ω} [ 1 , 6 ] , {g}_{25} \cdot \frac{Δ ϕ}{Δ ω} [ 2 , 5 ] , {g}_{34} \cdot \frac{Δ ϕ}{Δ ω} [ 3 , 4 ] ) \qquad ( 48 )$$

wherein optimized weights (g₀₇, g₁₆, g₂₅, g₃₄) can be determined as shown in Equation (3). Alternatively, the optimized weights can be iteratively derived as also explained herein.

### Derivation of Optimized Weights Equation with Cross Correlation

As an alternative, the cross correlation between random variables N₁ and N₂ may amount to ρ instead of 0, i.e.

$$ρ ( {N}_{1} , {N}_{2} ) = ρ \qquad ( 49 )$$

is applicable instead of Equation (34).

The standard deviation σ_{M} for the mean M can be determined:

$$\begin{matrix}{σ}_{M} = \sqrt{{( {g}_{1} {σ}_{1} )}^{2} + {( {g}_{2} {σ}_{2} )}^{2} + 2 ρ \cdot ( {g}_{1} {σ}_{1} ) \cdot ( {g}_{2} {σ}_{2} )} = \\ = \sqrt{{( {g}_{1} {σ}_{1} )}^{2} + {( ( 1 - {g}_{1} ) \cdot ( X {σ}_{1} ) )}^{2} + 2 ρ \cdot ( {g}_{1} {σ}_{1} ) \cdot ( ( 1 - {g}_{1} ) \cdot X {σ}_{1} )} = \\ = {σ}_{1} \cdot \sqrt{{g}_{1}^{2} \cdot ( 1 + {X}^{2} - 2 ρ X ) + {g}_{1} \cdot ( - 2 {X}^{2} + 2 ρ X ) + {X}^{2}}\end{matrix} \qquad ( 50 )$$

A partial derivative with respect to the weight g₁ is used to find the minimum standard deviation:

$$\begin{matrix}\frac{\partial ( {g}_{1}^{2} \cdot ( 1 + {X}^{2} - 2 ρ X ) + {g}_{1} \cdot ( - 2 {X}^{2} + 2 ρ X ) + {X}^{2} )}{\partial {g}_{1}} = \\ = 2 {g}_{1} \cdot ( 1 + {X}^{2} - 2 ρ X ) - 2 {X}^{2} + 2 ρ X\end{matrix} \qquad ( 51 )$$

Then, the weight is determined, which results in a minimum standard deviation, i.e.:

$$2 {g}_{{1}_{min}} \cdot ( 1 + {X}^{2} - 2 ρ X ) - 2 {X}^{2} + 2 ρ X = 0 \qquad ( 52 )$$

$${g}_{{1}_{min}} = \frac{{X}^{2} - ρ X}{{X}^{2} - 2 ρ X + 1} \qquad ( 53 )$$

Next, this optimized weight g₁_{ₘᵢₙ} is inserted back into Equation (50) to find the minimum standard deviation, i.e.:

$${σ}_{{M}_{min}} = {σ}_{1} \sqrt{\frac{{X}^{2} \cdot ( 1 - {ρ}^{2} )}{{X}^{2} - 2 ρ X + 1}} \qquad ( 54 )$$

### Example: Adjusting Weights Based on RSSI Measurements

A problem in wireless communication is interference noise from other transmission systems operating within shared frequency ranges. The interfering noise can reduce a signal-to-noise (SNR) power ratio for a particular channel, which then limits the ranging precision.

The signal and noise power levels can be determined, e.g., estimated, based on a received signal strength indicator (RSSI). Signal power may then be determined based on RSSI measurements during ranging transmissions. Further, noise power can be determined based on RSSI measurements by sampling the received signal during transmission pauses. Such transmission pauses can be any of the following: pauses before ranging sequences or pauses between channel changes within a ranging sequence.

Channels with lower SNR may contribute to a higher standard deviation of the total phase difference. Therefore, to optimize the standard deviation of the total phase difference, the weights in Equation (43) can be adjusted based on an SNR estimation given by RSSI measurements.

For example, weights may be reduced for channel pairs with a lower estimated SNR determined based on RSSI measurements, whereas weights may be increased for channel pairs with higher estimated SNR determined based on RSSI measurements.

The RSSI may be used to measure noise and/or signal power.

### Example: Brute Force Pairing

Brute force pairing is directed to any combination of channel pairings which are used to improve the precision.

The total number of unique channel pairings can be calculated with the binomial coefficient

$$( \begin{matrix}{K}_{f} \\ 2\end{matrix} ) . \qquad ( 55 )$$

An example comprises the total number of unique pairs arranged in a random or pseudo-random (or even deterministic) or any order. They can be iteratively added to gradually improve the precision as explained above with regard to the symmetrical pairing.

The process of iterative summation can be adjusted as follows:
a. The brute force pairing example uses overlapping pairs resulting in a cross-correlation between the pairs. So the equations for the optimized weighted mean for non-correlated variables in Equation (42) can be replaced with the augmented version according to Equation (53).
b. Furthermore, the utilization of overlapping channel may increase the complexity to the calculations. Therefore, a reframing of the channel pairs and their corresponding weights to individual channels and corresponding factors can be advantageous. Also, during the iterative summation procedure, the factors of individual channels can be tracked rather than the weights of the corresponding channel pairs.

The factor applied to each individual channel is equal to the weight of the respective channel's pair, divided with this particular pair's channel delta, with the correct sign included:

$$F [ n ] = + \frac{g [ m , n ]}{d [ m , n ]} \qquad ( 56 )$$

$$F [ m ] = - \frac{g [ m , n ]}{d [ m , n ]}$$

Since factors of equal magnitude and opposite sign are preferably added together, the total sum of factors applied to all channels equals 0, i.e.:

$${\sum }_{k = 0}^{{K}_{f} - 1} F [ k ] = 0 \qquad ( 57 )$$

The optimized total phase difference given in Equation (43) can thus be rewritten as:

$$Δ {Φ}_{tot} = {\sum }_{k = 0}^{{K}_{f} - 1} F [ k ] \cdot Φ [ k ] \qquad ( 58 )$$

In this example of brute force pairing, iteratively adding channel pairs in any order can be used to improve the precision.

### Example: Equidistant Pairing

An equidistant pairing is defined by an equal distance d used for each pair.

$$d = c o nst . \qquad ( 59 )$$

$${n}_{u} = {m}_{u} + d$$

The phase difference defined by the individual pairs and its standard deviation amounts to:

$$Δ {Φ}_{s} [ {m}_{u} , {n}_{u} ] = Δ {Φ}_{s} [ u ] = \frac{Φ [ {n}_{u} ] - Φ [ {m}_{u} ]}{d} \qquad ( 60 )$$

$${σ}_{Δ {Φ}_{s}} = σ \cdot \frac{\sqrt{2}}{d} \qquad ( 61 )$$

The total phase difference and the deviation from the total phase difference are:

$$Δ {Φ}_{tot} = \frac{1}{U} \cdot {\sum }_{u = 1}^{U} Δ {Φ}_{s} [ u ] \qquad ( 62 )$$

$${σ}_{Δ {Φ}_{tot}} = σ \cdot \frac{\sqrt{2}}{d \cdot \sqrt{U}} \qquad ( 63 )$$

wherein U is defined as the number of used pairs and u is the pair index.

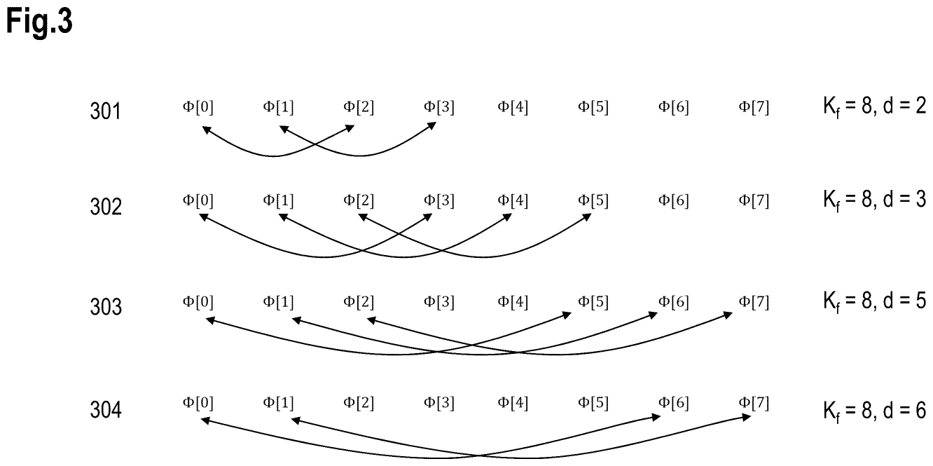

FIG. 3 shows a diagram comprising a total number of K_{f}=8 channels. Different distances d are visualized for example equidistant pairing. This is shown in FIG. 3 for d=2 in a subdiagram 301, for d=3 in a subdiagram 302, for d=5 in a subdiagram 303 and for d=6 in a subdiagram 304.

In all examples of FIG. 3, Φ[0] is used as a starting point and the equidistant pairing with the respective distance d is applied until there is no more channel pairing available. This results in some unused datapoints, i.e., Φ[4] to Φ[7] in subdiagram 301 or Φ[2] to Φ[5] in subdiagram 304.

The following applies:
for

$$d < \frac{{K}_{f}}{2} ,$$

the unused datapoints are on the right side, see subdiagrams 301 and 302; and
for

$$d > \frac{{K}_{f}}{2} ,$$

the unused datapoints are in the middle (i.e., between the datapoints), see subdiagrams 303 and 304.

Hence,
for d

$$\leq \frac{{K}_{f}}{2} ,$$

the number of used pairs U=d,
for d

$$> \frac{{K}_{f}}{2} ,$$

the number of used pairs U=K_{f}−d.

Therefore, the deviation according to Equation (63) can be summarized as follows:

$${σ}_{Δ {Φ}_{tot}} = σ \cdot \frac{\sqrt{2}}{d \cdot \sqrt{d}} , for d \leq \frac{{K}_{f}}{2} \qquad ( 64 )$$

$${σ}_{Δ {Φ}_{t o t}} = σ \cdot \frac{\sqrt{2}}{d \cdot \sqrt{{K}_{f} - d}} , for d > \frac{{K}_{f}}{2} \qquad ( 65 )$$

Advantageously, the distance d may be set to

$$d = \frac{2}{3} \cdot {K}_{f} \qquad ( 66 )$$

which, combined with Equation (65) results in an optimized deviation amounting to

$${σ}_{Δ {Φ}_{tot}} = σ \cdot \sqrt{\frac{13.5}{{K}_{f}^{3}}} \qquad ( 67 )$$

In equidistant pairing, the same factor is applied to all pairs. This means that the number of multiplications can be reduced to a single multiplication resulting in a reduced implementation complexity

$$\cdot \frac{1}{d \cdot U} \qquad ( 68 )$$

according to Equation (62).

### Example: Extended Equidistant Pairing

As indicated above, the equidistant pairing may result in unused datapoints (also referred to as residual datapoints). The number R of unused datapoints amounts to:

$$R = {K}_{f} - 2 \cdot U \qquad ( 69 )$$

An extended equidistant pairing is suggested that utilizes the residual datapoints by applying additional rounds of equidistant pairing. This solution further reduces the standard deviation.

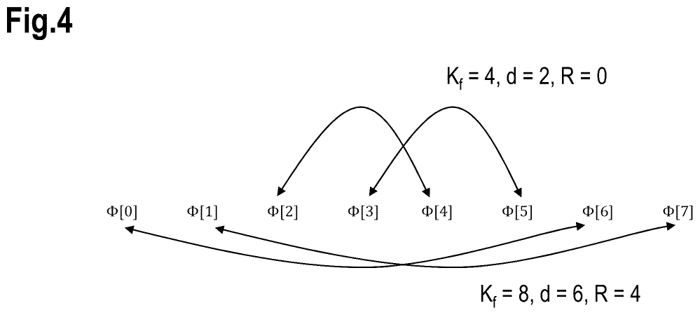

FIG. 4 shows an example of an extended equidistant pairing based on the subdiagram 304 shown in FIG. 3. Here, the datapoints Φ[2] to Φ[5] are used in a second round of equidistant pairing.

Hence, for the first round of equidistant pairing the following applies:

$${K}_{f} = 8 , d = 6 , U = 2 , R = 4$$

as is shown in subdiagram 304 of FIG. 3. In the second round or equidistant pairing an extended pairing is realized and the following applies (R of the first round equals to K_{f} of the second round):

$${K}_{f} = 4 , d = 2 , U = 2 , R = 0 .$$

Advantageously, the distance according to Equation (66) can be used.

It is noted that the resulting phase difference ΔΦ of each step may result in a different deviation. Hence, a weighted mean can be used to improve the result.

### Example: Equidistant Pairing with Binary Powers

The multiplication or division by values that are binary powers can be implemented as bit-shifting operations. This further reduces implementation costs.

The example of binary powers corresponds to the equidistant pairing scenario with the distance d and the number of used pairs U being (reduced to) binary powers.

An advantageous deviation can be obtained for

$${K}_{f} = d \cdot \frac{3}{2}$$

according to Equation (66). An implementation may utilize selecting K_{f} from

$${K}_{f} = {2}^{K} \cdot \frac{3}{2} \qquad ( 70 )$$

with positive integers K=1,2,3, . . .

Hence, also the number of used pairs

$$U = {K}_{f} - d$$

results in a binary power, because

$$U = {2}^{K} \cdot \frac{3}{2} - {2}^{K} = {2}^{K} \cdot \frac{1}{2} = {2}^{K - 1} \qquad ( 71 )$$

### Multipath Processing

The pairing patterns (and optionally the weights) can be selected based on amplitudes of IQ samples or values (for details about in-phase and quadrature components, reference is made to, e.g., https://en.wikipedia.org/wiki/In-phase_and_quadrature_components). One objective for this could be multipath mitigation.

Multipath mitigation depends on a relative distance to a direct path. Multipaths with higher relative distance may be easier to detect and to mitigate than close distance multipaths. A distance difference Δr_{MP} between the multipath distance r_{MP} and the directpath distance r_{DP} can be indicated as

$$Δ {r}_{MP} = {r}_{MP} - {r}_{DP} \qquad ( 72 )$$

For example, Bluetooth has a minimum relative distance for a full 2π amplitude period of

$${r}_{2 π} = \frac{c}{BW} \approx \frac{3 \cdot {10}^{8} \frac{m}{s}}{80 MHz} = 3.75 m \qquad ( 73 )$$

with BW being the bandwidth and c being the speed of light.

According to an example embodiment, three multipath (MP) categories can be defined:

First, a FAR MP category spanning across at least 2 peaks or at least 2 valleys of the amplitude signal of IQ samples. This results in a distance difference Δr_{MP} amounting to

$$Δ {r}_{MP} \geq {r}_{2 π} \qquad ( 74 )$$

Second, a MID MP category is defined comprising 1 peak and 1 valley of the amplitude signal of the IQ samples. This results in a distance difference Δr_{MP} amounting to

$$\frac{{r}_{2 π}}{2} < Δ {r}_{MP} < {r}_{2 π} \qquad ( 75 )$$

Third, a NEAR MP category is defined comprising 1 peak (and no valley) or 1 valley (and no peak) of the amplitude signal of the IQ samples. This results in a distance difference Δr_{MP} amounting to

$$Δ {r}_{MP} \leq \frac{{r}_{2 π}}{2} \qquad ( 76 )$$

It is noted that the following assumptions may preferably be made for the examples described herein: There is a single dominant multipath. The power of the multipath is less than the power of the directpath. A peak-search algorithm is applied to the amplitude of the IQ samples to determine peaks and valleys.

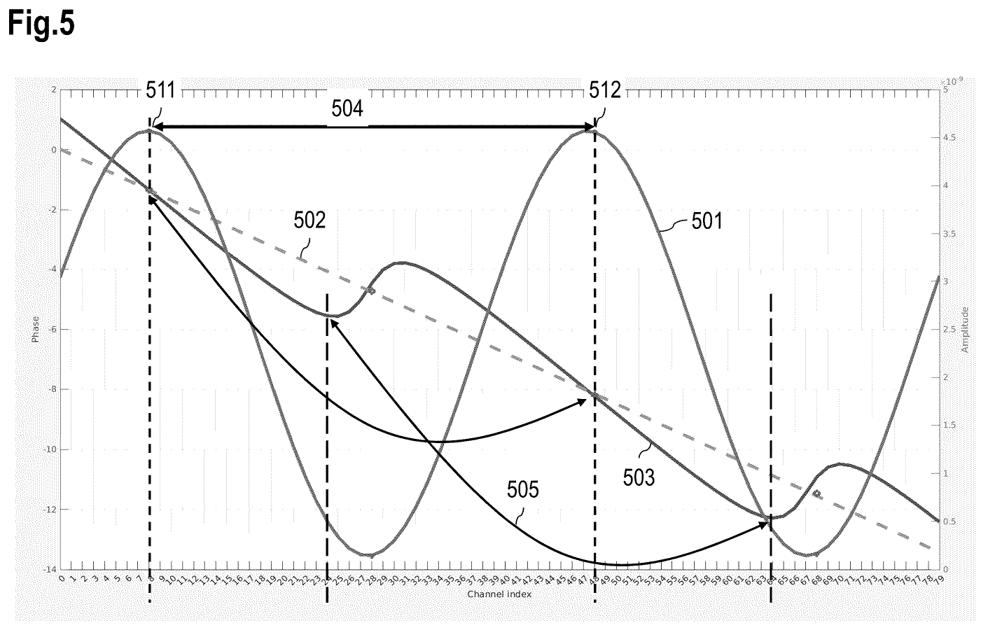

FIG. 5 shows a diagram that illustrates the FAR MP category utilizing equidistant pairing from peak to peak (or valley to valley).

An amplitude 501 of the IQ samples is depicted across the channels. The y-axis for the amplitude is on the right side of the diagram. The y-axis on the left side of the diagram shows the values for the phases. An ideal phase 502 and a phase 503 comprising the directpath and the multipath are shown. The pairing may be conducted as follows:
a. Take an amplitude at a point 511. Determine the channel k=8 for this point 511.
b. Determine the associated phase Φ[8] based on curve 503.
c. The pairing distance is determined as a distance 504 between two peaks resulting in a peak amplitude at a point 512. The associated channel for point 512 results in l=48.
d. Determine the associated phase Φ[48] based on curve 503.

Hence, the pairing comprises the phase values Φ[k] and Φ[l]. The next pair is based on the channels k+1 and l+1. The pairing can be continued with additional values i>1 until k+i reaches l. In this example due to distance 504, the difference between k and l amounts to 40. Hence, e.g., phase values Φ[k=24] and Φ[l=64] can be paired as is shown by an arrow 505. It can be seen that the differences between the curve 503 and the ideal phase 502 is identical at k=24 and l=64.

Determining the phase difference ΔΦ between the paired phases, the multipath bias is cancelled out within each pair due to

$$Δ Φ = Φ [ l ] - Φ [ k ] \qquad ( 77 )$$

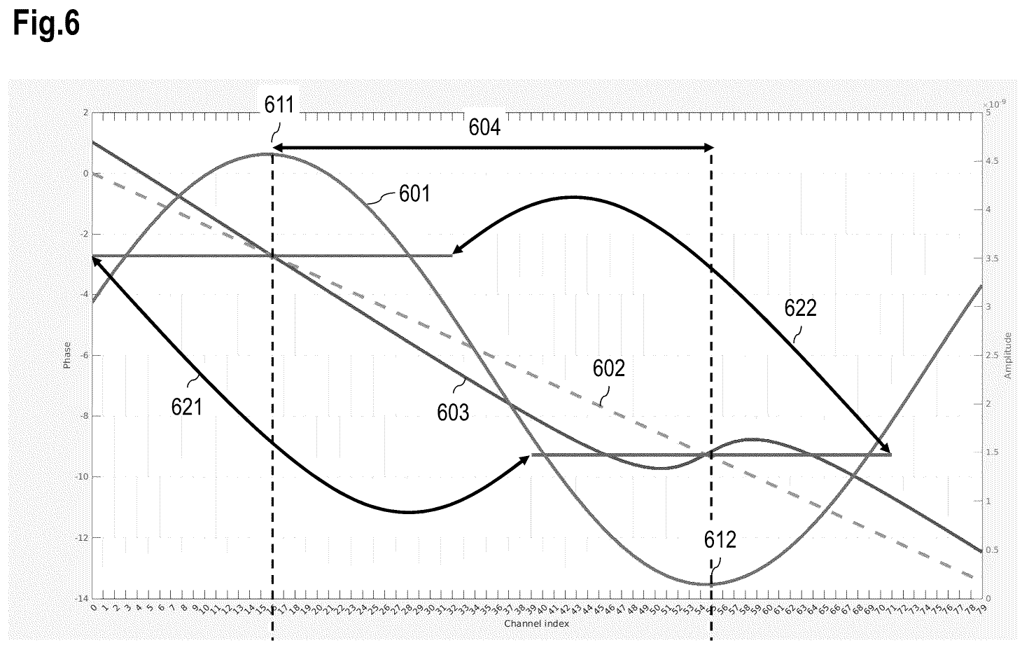

FIG. 6 shows a diagram that illustrates the MID MP category utilizing equidistant pairing from peak to valley.

An amplitude 601 of the IQ samples is depicted across the channels. The y-axis for the amplitude is on the right side of the diagram. The y-axis on the left side of the diagram shows the values for the phases. An ideal phase 602 and a phase 603 comprising the directpath and the multipath are shown. The pairing may be conducted as follows:
a. Take an amplitude at a point 611. Determine the channel k=16 for this point 611.
b. Determine the associated phase Φ[16] based on curve 603.
c. The pairing distance is determined as distance 604 between the peak and the valley resulting in an amplitude at a point 612. The associated channel for point 612 is l=55.
d. Determine the associated phase Φ[55] based on curve 603.

Hence, the pairing comprises the phase values Φ[k] and Φ[l]. The next pair is based on the channels k+1 and l+1. The pairing can be continued with additional values i>1 until k+i reaches l.

In this example due to distance 604, the difference between k and l amounts to 39. However, the multipath error is not cancelled out within the pair. Instead, the multipath error can be cancelled out by summing two pairs with opposite multipath induced biases.

With regard to FIG. 6, the following example applies with regard to the pairing (the numbers in the brackets indicate the channels):
[39, 0], see arrow 621, resulting in ΔΦ₁=Φ[39]−Φ[0]
[71, 32], see arrow 622, resulting in ΔΦ₂=Φ[71]−Φ[32]

Here, the multipath error can be cancelled out by summing ΔΦ₁ and ΔΦ₂. The opposite multipath induced biases, i.e., Φ[0] and Φ[32] can be found such that they are symmetrically located around the intersection point between the lines 602 and 603.

It is noted that this approach can also be applied for the FAR MP category having more than one peak and valley.

In the NEAR MP category, a combination of peak and valley does not fall into the window to be considered. Instead, there is either only a peak or only a valley. Hereinafter, two approaches are presented to reduce the multipath induced bias.

Assuming that the multipath bias contributes to a range error, a bias determined based on the amplitude deviation can be used to reduce the error.

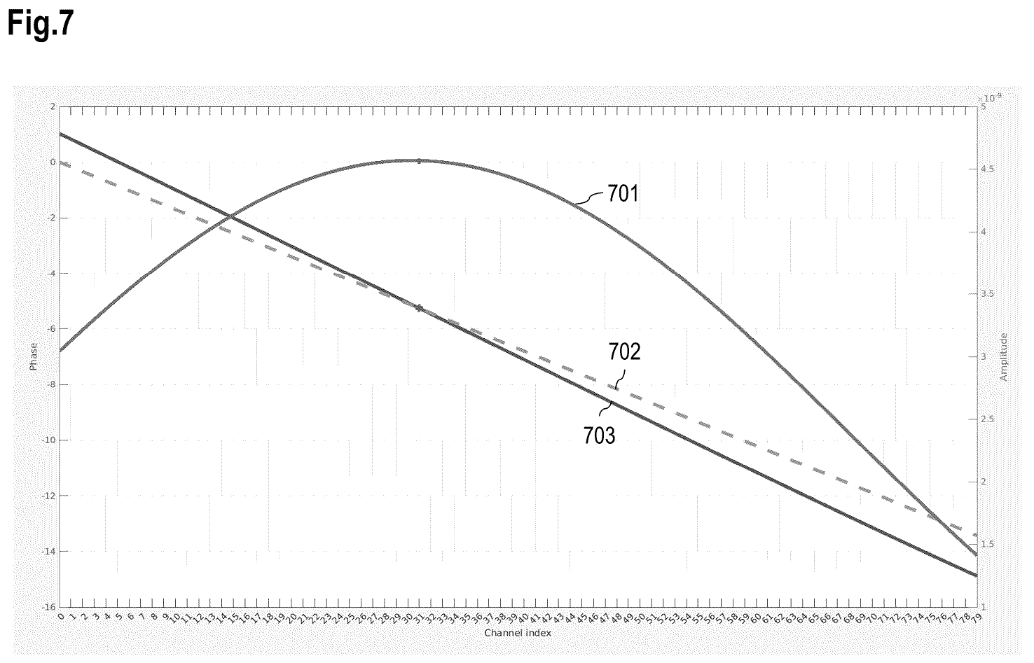

FIG. 7 shows a diagram that illustrates the NEAR MP category comprising an amplitude 701 of the IQ samples across the channels. The y-axis for the amplitude is on the right side of the diagram. The y-axis on the left side of the diagram shows the values for the phases. An ideal phase 702 and a phase 703 comprising the directpath and the multipath are shown.

As the multipath error that contributes to the phase 703 always adds some distance which is not in the directpath, a negative bias based on the amplitude deviation can be applied to improve the result. For example, if the deviation gets bigger, the bias can be increased as well.

As an alternative to cope with the NEAR MP category, the range of the pairing patterns can be limited:

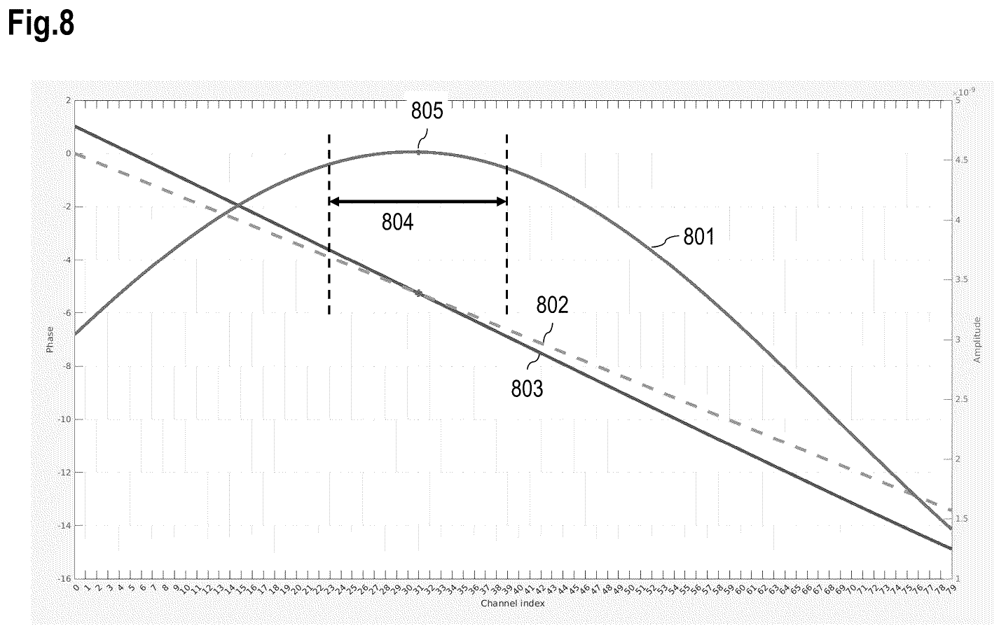

FIG. 8 shows a diagram that illustrates the NEAR MP category with a limited range for the pairing patterns. An amplitude 801 shows an amplitude of the IQ samples across the channels. The y-axis for the amplitude is on the right side of the diagram. The y-axis on the left side of the diagram shows the values for the phases. An ideal phase 802 and a phase 803 comprising the directpath and the multipath are shown.

The pairing patterns can be limited to a range 804, e.g., around a peak 805 of the amplitude 801 of the IQ samples. It is noted that the range could also be applied around a valley (instead of the peak). This solution bears the advantage that the pairing patterns used within the range 804 are directed to the phase 803 with the smallest variation (compared to the variation from the ideal phase 802 outside the range 804).

### Additional Aspects and Embodiments

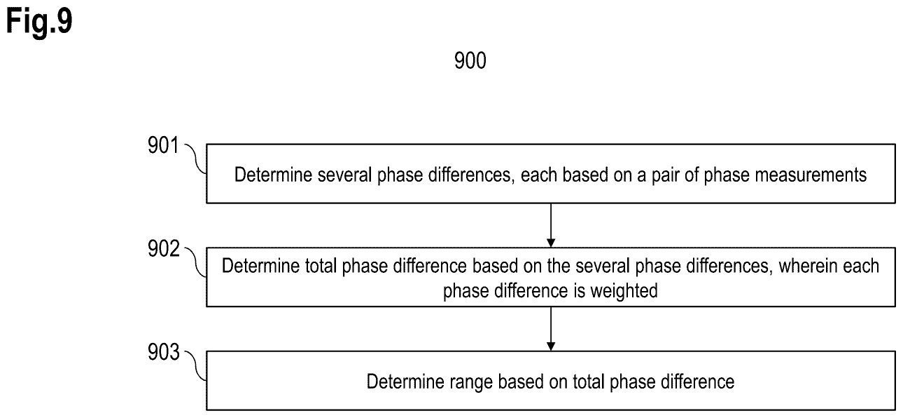

FIG. 9 illustrates an example flow diagram of a method 900 for operating a device to conduct range measurements. The method 900 may be performed by a device utilizing hardware, software, or combinations of hardware and software.

In operation 901, several phase differences are determine, wherein each phase difference is based on a pair of phase measurements.

In operation 902, a total phase difference is calculated based on the several phase differences. Also, each of the phase differences is weighted.

In operation 903, the range is determined based on the total phase difference.

It is noted that it is an option that the weights are equal for at least two of the phase differences. It is in particular an option that the weights are equal for all phase differences. Such an example results in equidistant pairing. In a particular example of equidistant pairing, the weights for the phase differences may be set to 1.

As an option, determining the total phase difference in operation 902 may comprise: reducing or minimizing a deviation for each of the phase differences or for a selection of phase differences.

As yet another option, determining the several phase differences according to operation 901 may further comprise: reducing or minimizing the deviation by selecting pairs of phase measurements and/or by adjusting the weights for the phase differences.

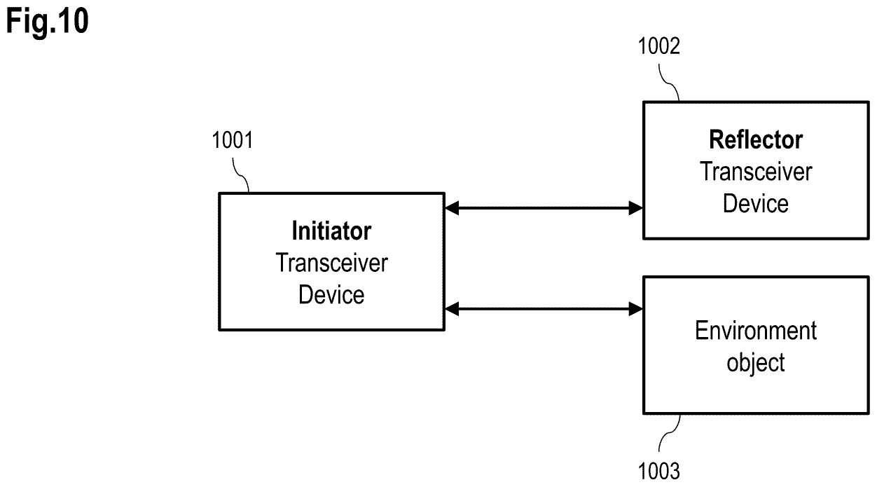

FIG. 10 shows an example block diagram visualizing different use cases for a system implementation. An initiator 1001 conveys a wireless signal to a reflector 1002 and/or to an object of the environment 1003. The initiator 1001 as well as the reflector can be realized as transceiver devices. The reflector 1002 as well as the object of the environment 1003 may reflect a portion of the wireless signal to the initiator 1001.

Examples described herein can be applied to range measurements between two transceivers, in this example between the initiator 1001 and the reflector 1002, also referred to as transceiver-to-transceiver ranging. As an alternative (or in addition), range measurement can be applied between the initiator 1001 and the object of the environment 1003, also referred to as transceiver-to-object ranging.

Transceiver-to-transceiver ranging can be conducted, e.g., for localization, for navigation and/or for secure access purposes. The initiator 1001 initiates the range measurement, the reflector 1002 response to this initiation. Example use cases for Transceiver-to-transceiver ranging may include, without limitation:
A smartphone is used as the initiator to locate a wireless headphone (e.g., earbud) or another wireless item (e.g., a tracking device attached to a key ring). In this example, the wireless headphone and the wireless item are transceiver devices used as reflectors.
A smartphone or another wireless device is used to unlock a door, e.g., a car door or a smart lock. The smartphone/wireless device may be the initiator and the car door/smart lock may be used as reflectors.
A beacon tracks a smartphone or a smart watch, e.g., during indoor movement of a user. This example can be used, e.g., for indoor sport or indoor navigation. The smartphone/smart watch can act as either initiator or reflector. Hence the beacon assumes the respective other role, i.e., reflector or initiator.
A smartphone or a smart watch are used for secure payment. The smartphone/smart watch can act as either initiator or reflector. Hence the other side, here payment device, assumes the respective other role, i.e., reflector or initiator.

Transceiver-to-object ranging solutions may also comprise radar applications that conduct range measurement and/or object detection. Examples of transceiver-to-object ranging solutions may include, without limitation:
A computer logs off when a user moves away from the computer. Here, the object is the user, which is (no longer) detected by the computer. Accordingly, a login procedure may be started when a user is detected in front of the computer.
A beacon determines and/or tracks the presence of a person and conducts a predefined action, e.g., switching lights on/off, switching air conditioning on/off, adjusting illumination level, adjusting air conditioning.
A radar device can be used to detect objects that are not visible to the human eye. For example, objects that are underground or behind barriers can be detected by radar signals.

The wireless signal addressed herein may comprise at least one of the following: a Wireless Fidelity (WiFi) signal, a Bluetooth (BT) signal, an Ultrawideband (UWB) signal.

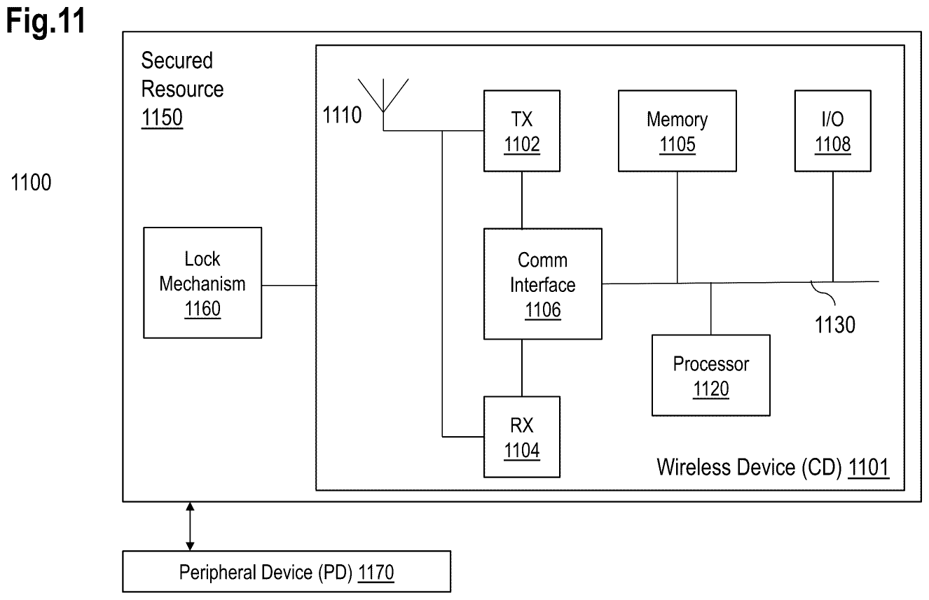

FIG. 11 illustrates a block diagram of a system 1100 useable for range measurement. In this embodiment, a wireless device 1101 acts as a central device (CD) of the wireless network and may be referred to herein as a receiving device. Further, a wireless device 1170 acts as a peripheral device (PD) of the wireless network and may be referred to herein as a transmission device. The system 1100 may include a secured resource 1150, e.g., that is secured using a lock mechanism 1160, where the peripheral wireless device 1170 is adapted to gain access to the secured resource 1150 via the lock mechanism 1160. The secured resource 1150 may be, for example, an enclosure such as a vehicle, a building, a residence, a garage, a shed, a vault, or the like. The secured resource 1150 may also be a computer system, industrial equipment, or other items requiring secured access via the lock mechanism 1160, which can be, for example, a digital locking mechanism. In some embodiments, the lock mechanism 1160 may be integrated together with the central wireless device 1101.

In some embodiments, the peripheral wireless device 1170 is any one of multiple peripheral wireless devices, as the central wireless device 1101 may be adapted to communicate with any or all of such peripheral wireless devices. In some embodiments, the peripheral wireless device 1170 is a mobile device such as a mobile phone, a smart phone, a smart watch, a pager, an electronic transceiver, a tablet, a keyless entry device, or the like. In these embodiments, the peripheral wireless device 1170 may be adapted to gain access to the secured resource 1150 by transmitting data including a frame synchronization pattern (e.g., BLE channel sounding (BLE CS) synchronization pattern) encapsulated in a frame synchronization packet. The peripheral wireless device 1170 may further comprise the same or similar components as the central wireless device 1101, the descriptions of which are not repeated for brevity.

In some embodiments, the central wireless device 1101 includes, but is not be limited to, a transmitter or TX 1102 (e.g., a PAN transmitter), a receiver or RX 1104 (e.g., a PAN receiver), a communications interface 1106, one or more antennas 1110, a memory 1105, one or more input/output (I/O) devices 1108 (such as a display screen, a touch screen, a keypad, and the like), and a processor 1120. These components may all be coupled to a communications bus 1130.

In some embodiments, a separate antenna can be employed for each of the transmitter 1102 and/or receiver 1104, and so the antenna 1110 is illustrated for simplicity. In some embodiments, the memory 1105 may include storage to store instructions executable by the processor 1120 and/or data generated by the communications interface 1106. In some embodiments, front-end components such as the transmitter 1102, the receiver 1104, the communications interface 1106, and the one or more antennas 1110 described herein may be adapted with or configured for PAN-based frequency bands, e.g., Bluetooth® (BT), BLE, Wi-Fi®, Zigbee®, Z-wave™, and the like.

In some embodiments, the communications interface 1106 is integrated with the transmitter 1102 and the receiver 1104, e.g., as a front-end of the wireless device 1101. The communications interface 1106 may coordinate, as directed by the processor 1120, to request/receive packets from the peripheral wireless device 1170. The communications interface 1106 may process data symbols received by the receiver 1104 in a way that the processor 1120 can perform further processing as described herein.

Various embodiments of the ranging measurement described herein may include various operations. These operations may be performed and/or controlled by hardware components, digital hardware and/or firmware/programmable registers (e.g., as implemented in computer-readable medium), and/or combinations thereof. For example, the operations may be performed by a general-purpose computer or a processing system executing computer program stored in a computer-readable medium. The methods and illustrative examples described herein are not inherently related to any particular device or other apparatus. Various systems (e.g., such as a wireless device operating in a near or long field environment, pico area network, wide area network, etc.) may be used in accordance with the teachings described herein, or it may prove convenient to construct more specialized apparatus to perform the method steps.

A computer-readable medium used to implement operations of various aspects of the disclosure may be non-transitory computer-readable storage medium that may include, but is not limited to, electromagnetic storage medium, magneto-optical storage medium, read-only memory (ROM), random-access memory (RAM), erasable programmable memory (e.g., EPROM and EEPROM), flash memory, or another now-known or later-developed non-transitory type of medium that is suitable for storing configuration information.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “may include”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing. For example, certain operations may be performed, at least in part, in a reverse order, concurrently and/or in parallel with other operations.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware-for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component.

Additionally, “configured to” or “configurable to” can include generic structure (e.g., generic circuitry) that is manipulated by firmware (e.g., an FPGA) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the claimed subject matter to the precise forms disclosed. Many modifications and variations are possible in view of the above teachings. The embodiments were chosen and described in order to explain the principles of the embodiments and its practical applications, to thereby enable others skilled in the art to utilize the embodiments and various modifications as may be suited to the particular use contemplated. Accordingly, the present embodiments are to be considered as illustrative and not restrictive, and the claimed subject matter is not to be limited to the details given herein, but may be modified within the scope and equivalents of the appended claims.

### Further Example Embodiments

Examples suggested herein may be based on at least one of the following solutions. Combinations of the following features could be utilized in order to reach a desired result. The features of the method could be combined with any feature(s) of the device, apparatus or system or vice versa. The “embodiments” mentioned herein are merely examples of features that could be optionally introduced. These embodiments are no limitation of the independent claims.

A method is suggested for phase based range measurement comprising:
determining a plurality of phase differences, wherein each of the plurality of phase difference is based on a pair of phase measurements;
determining a total phase difference based on the plurality of phase differences, wherein each of the plurality of phase difference is weighted; and
determining a range based on the total phase difference.

It is noted that it is an option that the weights are equal for at least two of the phase differences. It is in particular an option that the weights are equal for all phase differences. Such an example results in equidistant pairing. In a particular example of equidistant pairing, the weights for the phase differences may be set to 1.

According to an embodiment, determining the total phase difference comprises reducing or minimizing a deviation for each of the plurality of phase differences or for a selection of the plurality of phase differences.

According to an embodiment, determining the total phase difference further comprises reducing or minimizing the deviation by selecting pairs of phase measurements and/or by adjusting the weights for the plurality of phase differences.

According to an embodiment, determining the plurality of phase differences further comprises selecting pairs of phase measurements, wherein the pairs are arranged symmetrically across frequency channels.

According to an embodiment, the plurality of phase differences are determined by pairs of phase measurements, wherein the pairs are arranged equidistant across frequency channels.

According to an embodiment, the plurality of phase differences are determined by pairs of phase measurements, wherein the pairs are arranged equidistant across the frequency channels, wherein at least two groups of pairs with different distances are provided, wherein at least one group comprises at least two pairs.

According to an embodiment, determining the plurality of phase differences comprises at least one of selecting pairs of phase measurements with a distance amounting to a power of 2, and selecting a number of pairs of phase measurements, wherein this number amounts toa power of 2.

According to an embodiment, determining the plurality of phase differences comprises selecting pairs of phase measurements based on an amplitude of IQ values and/or based on an amplitude of RSSI measurements.

According to an embodiment, determining the weight of each of the plurality of phase differences is based on the amplitude of the IQ values and/or the RSSI measurements.

Further, an example apparatus is suggested, comprising:
a receiver configured to receive radio frequency (RF) signals associated with a plurality of phase values;
a processing system configured to:
   determine a plurality of phase differences, wherein each phase difference is based on a pair of phase measurements;
   determine a total phase difference based on the plurality of phase differences, wherein each of the phase differences is weighted; and
   determine a range of a source of at least a portion of the RF signals, based on the total phase difference.

According to an embodiment, to determine the total phase difference, the processing system is configured to reduce or minimize a deviation for each of the phase differences or for a selection of the phase differences.

According to an embodiment, to determine the total phase difference, the processing system is configured to reduce or minimize the deviation by selecting pairs of phase measurements and/or by adjusting the weights for the phase differences.

According to an embodiment, to determine the plurality of phase differences, the processing system is configured to select pairs of phase measurements, wherein the pairs are arranged symmetrically across frequency channels.

According to an embodiment, the processing system is configured to determine the plurality of phase differences by pairs of phase measurements, wherein the pairs are arranged equidistant across frequency channels.

According to an embodiment, the processing system is configured to determine the plurality of phase differences by pairs of phase measurements, wherein the pairs are arranged equidistant across the frequency channels, wherein at least two groups of pairs with different distances are provided, wherein at least one group comprises at least two pairs.

According to an embodiment, to determine the several phase differences, the processing system is configured to:
select pairs of phase measurements with a distance amounting to a power of 2; and
select a number of pairs of phase measurements, wherein this number amounts toa power of 2.

According to an embodiment, to determine the several phase differences, the processing system is configured to: select pairs of phase measurements based on an amplitude of IQ values and/or based on an amplitude of RSSI measurements.

According to an embodiment, the processing system is configured to determine the weight of each phase difference based on the amplitude of the IQ values and/or the RSSI measurements.

Also, an example system is provided, comprising:
an initiating device comprising a transceiver; and
a reflector device, wherein the initiating device is configured to receive wireless signals from the reflector device, and based on the wireless signals:
   determine several phase differences, wherein each phase difference is based on a pair of phase measurements,
   determine a total phase difference based on the several phase differences, wherein each of the phase difference is weighted,
   determine a range based on the total phase difference, and
   initiate an action based on the determined range.

According to an embodiment, the reflector device is one of the following:
a reflector device comprising a transceiver that transmits the wireless signals; or
an object that provides the wireless information via one or more physical reflections of radio waves.

An example solution may be based on a computer program product directly loadable into a memory of a digital computer, comprising software code portions for performing the steps of the method as described herein.

In addition, the problem stated above may be solved by a computer-readable medium, e.g., storage of any kind, having computer-executable instructions adapted to cause a computer system to perform the method as described herein.

Furthermore, the problem stated above is solved by a communications system comprising at least one device or apparatus as described herein.

1. A method for phase based range measurement comprising:
determining a plurality of phase differences, wherein each of the plurality of phase difference is based on a pair of phase measurements;
determining a total phase difference based on the plurality of phase differences, wherein each of the plurality of phase difference is weighted; and
determining a range based on the total phase difference.

2. The method according to claim 1, wherein determining the total phase difference comprises reducing or minimizing a deviation for each of the plurality of phase differences or for a selection of the plurality of phase differences.

3. The method according to claim 2, wherein determining the total phase difference further comprises reducing or minimizing the deviation by selecting pairs of phase measurements and/or by adjusting the weights for the plurality of phase differences.

4. The method according to claim 1, wherein determining the plurality of phase differences further comprises selecting pairs of phase measurements, wherein the pairs are arranged symmetrically across frequency channels.

5. The method according to claim 1, wherein the plurality of phase differences are determined by pairs of phase measurements, wherein the pairs are arranged equidistant across frequency channels.

6. The method according to claim 5, wherein the plurality of phase differences are determined by pairs of phase measurements, wherein the pairs are arranged equidistant across the frequency channels, wherein at least two groups of pairs with different distances are provided, wherein at least one group comprises at least two pairs.

7. The method according to claim 5, wherein determining the plurality of phase differences comprises at least one of selecting pairs of phase measurements with a distance amounting to a power of 2, and selecting a number of pairs of phase measurements, wherein this number amounts toa power of 2.

8. The method according to claim 1, wherein determining the plurality of phase differences comprises selecting pairs of phase measurements based on an amplitude of IQ values and/or based on an amplitude of RSSI measurements.

9. The method according to claim 8, wherein determining the weight of each of the plurality of phase differences is based on the amplitude of the IQ values and/or the RSSI measurements.

10. An apparatus, comprising:
a receiver configured to receive radio frequency (RF) signals associated with a plurality of phase values;
a processing system configured to:
determine a plurality of phase differences, wherein each phase difference is based on a pair of phase measurements;
determine a total phase difference based on the plurality of phase differences, wherein each of the phase differences is weighted; and
determine a range of a source of at least a portion of the RF signals, based on the total phase difference.

11. The apparatus of claim 10, wherein to determine the total phase difference, the processing system is configured to reduce or minimize a deviation for each of the phase differences or for a selection of the phase differences.

12. The apparatus of claim 11, wherein to determine the total phase difference, the processing system is configured to reduce or minimize the deviation by selecting pairs of phase measurements and/or by adjusting the weights for the phase differences.

13. The apparatus of claim 10, wherein to determine the plurality of phase differences, the processing system is configured to select pairs of phase measurements, wherein the pairs are arranged symmetrically across frequency channels.

14. The apparatus of claim 10, wherein the processing system is configured to determine the plurality of phase differences by pairs of phase measurements, wherein the pairs are arranged equidistant across frequency channels.

15. The apparatus according to claim 14, wherein the processing system is configured to determine the plurality of phase differences by pairs of phase measurements, wherein the pairs are arranged equidistant across the frequency channels, wherein at least two groups of pairs with different distances are provided, wherein at least one group comprises at least two pairs.

16. The apparatus of claim 10, wherein to determine the plurality of phase differences, the processing system is configured to:
select pairs of phase measurements with a distance amounting to a power of 2; and
select a number of pairs of phase measurements, wherein this number amounts toa power of 2.

17. The apparatus of claim 10, wherein to determine the plurality of phase differences, the processing system is configured to:
select pairs of phase measurements based on an amplitude of IQ values and/or based on an amplitude of RSSI measurements.

18. The apparatus of claim 17, wherein the processing system is configured to:
determine the weight of each phase difference based on the amplitude of the IQ values and/or the RSSI measurements.

19. A system comprising:
an initiating device comprising a transceiver; and
a reflector device, wherein the initiating device is configured to receive wireless signals from the reflector device, and based on the wireless signals:
determine several phase differences, wherein each phase difference is based on a pair of phase measurements,
determine a total phase difference based on the several phase differences, wherein each of the phase difference is weighted,
determine a range based on the total phase difference, and
initiate an action based on the determined range.

20. The system according to claim 19, wherein the reflector device is one of the following:
a reflector device comprising a transceiver that transmits the wireless signals; or
an object that provides the wireless signals via one or more physical reflections of radio waves.
